(19) United States
(12) Patent Application Publication
(10) Pub. No.: US 2004/0002865 A1
(43) Pub. Date: Jan. 1, 2004

(54) Apparatus and method for automatically updating call redirection databases utilizing semantic information

(76) Inventors: Norman C. Chan, Louisville, CO (US); Larry J. Shaffer, Thornton, CO (US); Danny M. Wages, Boulder, CO (US)

Correspondence Address: John C. Moran, Attorney, P.C, 4120 E. 115th Place, Thornton, CO, 80233, US

(21) Appl. No.: 10/184,524

(22) Filed: Jun. 28, 2002

(51) Int. Cl. G10L 11/00

(52) U.S. Cl. 704/275

(57) ABSTRACT

When an automatic call redirection operation is to be performed, a semantic process is used to determine semantic information being received back from the destination endpoint to which the call was directed. Advantageously, the semantic process will determine that the call has been redirected to a destination point which is no longer valid. Utilizing the semantic information received about the destination endpoint from a system to which the destination endpoint was connected, the semantic process extracts the new telephone number if it is present. This new telephone number is then utilized to update the database utilized by the automatic call redirection operation.

### TECHNICAL FIELD

This invention relates to telecommunication systems in general, and in particular, to the capability of updating databases.

### BACKGROUND OF THE INVENTION

Telecommunication switching systems maintain directory listings that are used for outgoing call placement. One example of this is an enterprise switching system (also referred to as a PBX) having a database of directory listings for use with coverage of calls redirected off the network (CCRON). The enterprise switching system transfers an incoming call to multiple outgoing numbers and may encounter a voice message from the public telephone switching network indicating that a directory number has changed. The problem exists that in accordance with the prior art, the only way that the database of directory listings can be updated is for a human being to manually update the database such as a party changing their own telephone number. One example of a CCRON application is the utilization of in-call coverage on the enterprise switching system where the individual transfers the incoming call destined for their desk telephone to their cellular telephone. Within the prior art, it is also well known to utilize enterprise switching systems to provide call center services. A common function performed by call centers is for a merchant to periodically solicit former customers in the hope that these customers will buy more products using predictive dialing. Predictive dialing is a method by which the automatic call distribution center automatically places a call to a telephone before an agent is assigned to handle that call. If the customer has changed their telephone number since the last transaction, the merchant's database is out-of-date and has to be updated manually at the cost of using of a telemarketing agent. Not only is there the cost of paying someone to manually update the database of telephone listings, but there is the problem of actually detecting that there is a need to do this.

### SUMMARY OF THE INVENTION

This invention is directed to solving these and other problems and disadvantages of the prior art. According to an embodiment of the invention, when an automatic call redirection operation is to be performed, a semantic process is used to determine semantic information being received back from the destination endpoint to which the call was directed. Advantageously, the semantic process will determine that the call has been redirected to a destination point which is no longer valid. Utilizing the semantic information received about the destination endpoint from a system to which the destination endpoint was connected, the semantic process extracts the new telephone number if it is present. This new telephone number is then utilized to update the database utilized by the automatic call redirection operation.

### BRIEF DESCRIPTION OF THE DRAWING

FIG. 1 illustrates a utilization of an automatic redirection database updating operation in accordance with one embodiment of the invention;

FIG. 2 illustrates, in block diagram form, an embodiment of a redirection database controller in accordance with the invention;

FIG. 3 illustrates, in block diagram form, one embodiment of an automatic speech recognition block;

FIG. 4 illustrates a high level block diagram of an embodiment of an inference engine;

FIG. 5 Illustrates, in block diagram form, details of an implementation of an embodiment of the inference engine;

FIGS. 6-14 illustrate, in flowchart form, steps for implementing an embodiment of an automatic speech recognition unit; and

FIG. 15 illustrates, in flowchart form, steps performed in an implementation of the invention;

### DETAILED DESCRIPTION

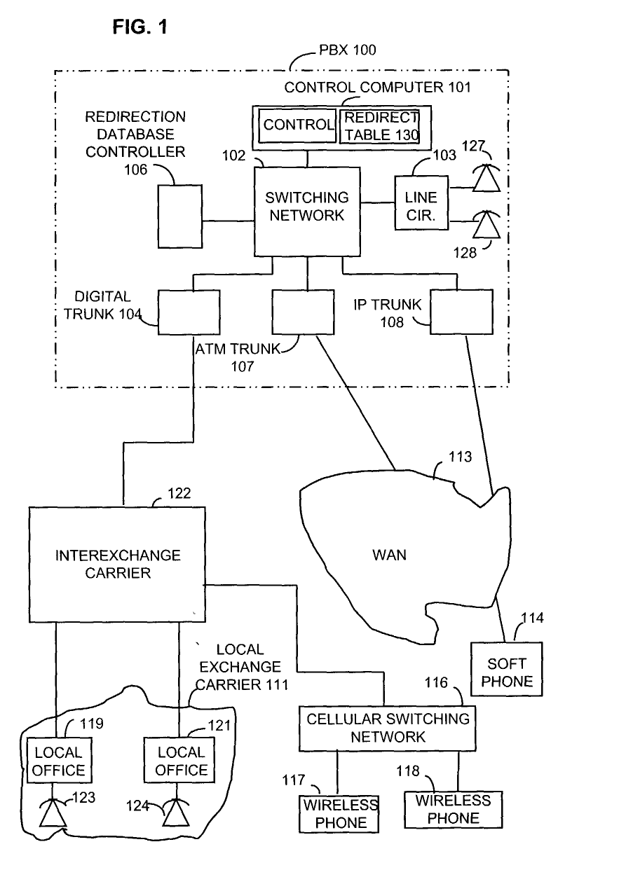

FIG. 1 illustrates a telecommunication system utilizing redirection database controller 106 to automatically update the database of telephone listings that is utilized by control computer 101 of PBX 100 (also referred to as a business communication system or enterprise switching system) to automatically redirect calls. However, one skilled in the art could readily see how to utilize redirection database controller 106 in interexchange carrier 122 or local offices 119 and 121, in cellular switching network 116, and in some portions of wide area networks (WAN) 113. Redirection database controller 106 is illustrated as being a part of PBX 100 as an example. As can be seen from FIG. 1, PBX 100 comprises control computer 101, switching network 102, line circuits 103, digital trunk 104, ATM trunk 107, IP trunk 108, and redirection database controller 106. To better understand the operations of the system of FIG. 1, consider the following example. Telephone 123 connected to local office 119 places a call to telephone 127 that is part of PBX 100 via interexchange carrier 122 and local office 119. Further assume, that calls directed to telephone 127 are automatically redirected by control computer 101 to wireless phone 118 connected to cellular switching network 116. When control computer 101 determines that it is doing an automatic redirection of the call received from telephone 123, it connects redirection database controller 106 into the voice path of the call as it is redirected to cellular switching network 116 via interexchange carrier 122. Note, that redirection database controller 106 is only placed in the voice path in a half duplex mode such that it receives only voice information from cellular switching network 116. If the call is routed to wireless phone 118 by cellular switching network 116, redirection database controller 106 performs no operations. However, if cellular switching network 116 transmits an automated message indicating that the telephone number of wireless phone 118 has been changed, redirection database controller 106 extracts from the message being received from cellular switching network 116 the new telephone number. Redirection database controller 106 then interacts with control computer 101 to update the automatic redirection telephone listing for telephone 127. Even if wireless phone 118 is still receiving service from cellular switching network 116, cellular switching network 116 may transmit other voice messages indicating that wireless phone 118 is not available. For example, cellular switching network 116 may transmit a message stating that wireless phone 118 has roamed out of the area covered by cellular switching network 116. Redirection database controller 106 has to properly interpret such a message and not take any actions that would cause control computer 101 to update the telephone listing for telephone 127.

If PBX 100 was being utilized in a call center as is well known in the art, telephones 127 and 128 rather than being simple analog or digital telephones would be agent positions and have more sophisticated equipment. Consider the example where PBX 100 is performing a call function and PBX 100 is performing the function of predictive dialing. In automatic outward calling, control computer 101 utilizes a telephone list to automatically place telephone calls to telephones such as telephone 123. If a human answers telephone 123, control computer 101 then determines an available agent to place on this call. When control computer 101 performs an automatic outward calling operation, control computer 101 places redirection database controller 106 into the voice path with the called telephone. If for telephone 123, local office 119 indicates that the telephone number of the individual that used to have the telephone number of telephone 123 has been changed, redirection database controller 106 properly interprets this message and extracts the new telephone number. Redirection database controller 106 then communicates this new telephone number to control computer 101 so that the telephone listing can be updated.

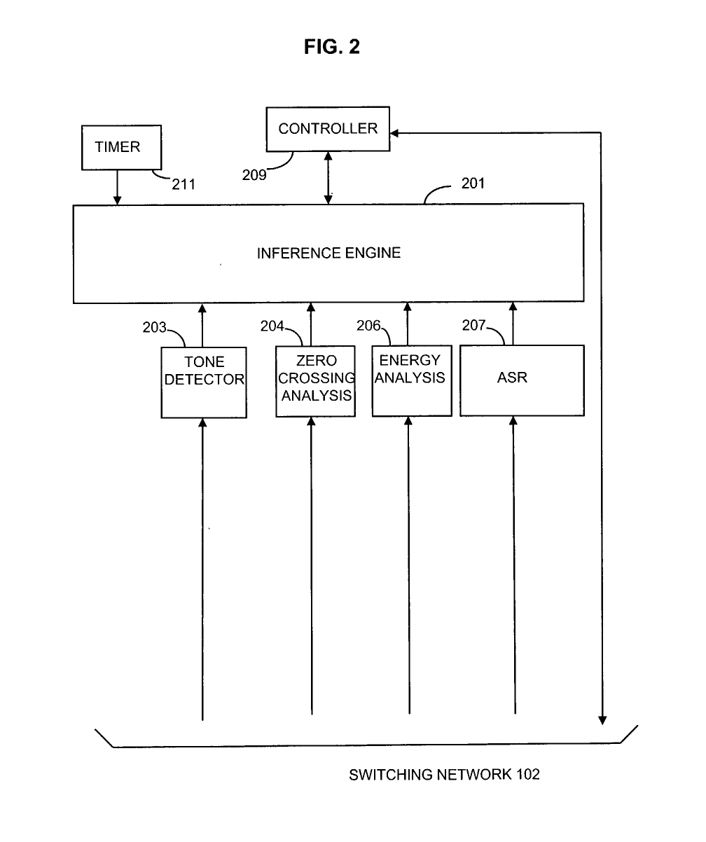

FIG. 2 illustrates an embodiment of redirection database controller 106 in accordance with the invention. Overall control of redirection database controller 106 is performed by controller 209 in response to control messages received from control computer 101. In addition, controller 209 is responsive to the results obtained by inference engine 201 to transmit these results to control computer 101. If necessary, one skilled in the art could readily see that an echo canceller could be used to reduce any occurrence of echoes in the audio information being received from switching network 102. Such an echo canceller could prevent severe echoes in the received audio information from degrading the performance of blocks 203-207.

A short discussion of the operations of blocks 203-207 is given in this paragraph. Each of these blocks is discussed in greater detail in later paragraphs. Tone detection block 203 is utilized to detect the tones used within the telecommunication switching system to determine how the redirected call is being handled. Zero crossing analysis block 204 also includes peak-to-peak analysis and is used to determine the presence of voice in an incoming audio stream of information. Energy analysis 206 is used to determine the presence of an automated voice response system and also to assist in the determination of tone detection. Automatic speech recognition (ASR) block 207 is described in greater detail in the following paragraphs.

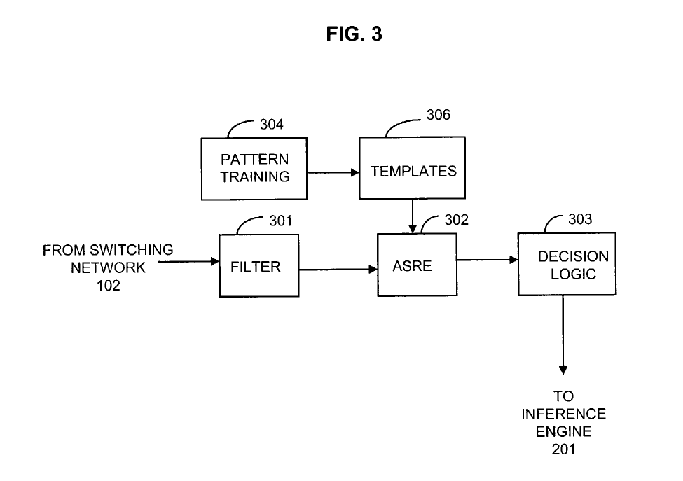

FIG. 3 illustrates, in block diagram form, greater details of ASR 207. Filter 301 receives the speech information from switching network 102 and performs filtering on this information utilizing techniques well known to those skilled in the art. The output of filter 301 is communicated to automatic speech recognizer engine (ASRE) 302. ASRE 302 is responsive to the speech information and a template defining the type of operation which is received from templates block 306 and performs phrase spotting so as to determine how the redirected call has been terminated. To perform this operation, ASRE 302 is speaker independent since any large number of speakers can be at a destination endpoint. Further, ASRE 302 rejects irrelevant sounds: out-of-domain speech, background speech, background acoustic speech, and noise. ASRE 302 implements a small, limited domain vocabulary in which it is capable of performing phrase recognition. ASRE 302 is implementing a grammar of concepts. Where a concept may be a greeting, identification, price, time, results, action, etc.

An example of a message that ASRE 302 searches for to change the redirect table is “Welcome to AT&T wireless services . . . the cellular customer you have called cannot be reached as dialed. The cellular customer you have called has a new telephone number . . . the number is . . . for 75 cents AT&T can forward your call to the new number”

The following are cases of words that lead to a change of the redirect table:

. . . the new number is . . .

. . . . disconnected . . .

. . . non-working number . . . please check . . .

. . . office hours . . .

The formal grammar specifications for the above cases is:

classify(answer, number_change(Number))-->{new,number,is}(collect_digits(Number))

classify(noAnswer, network)->[disconnected]|{in,service}|{your,call, cannot}|[prefix]|{has,been,changed}|{non-working,number}|{please,check}|[assistance]|{what,number}|[number]|[customer,dialed].

The following are cases of words that do not lead to a change of the redirect table:

. . . office closed . . .

. . . sorry . . .

. . . closed . . .

Formal grammar specifications for the above cases is:

classify(answer, am_vm(res))-->[reached]|{you,have}|[sorry]|[tone]|[we] [we're]|{I,am}|[I'm]|{I'm,not}|{I,cannot}|[can't]|{I,will}|[answering]|[leave]|[home]|[return]|[please]|[machine]|[beep]|[unable]|[phone]|[calling]|[called]|[residence]|[recording]|[message]|{there,is}|{no,one}|[name]|[number]|[time].

classify(answer, am_vm(bus))-->[welcome]|[agents]|[press]|[thank]|[thanks]|[office]|[closed]|[weather]|[today]|day_of_week|[temperature].

The preceding grammar illustration would be used as grammar for detecting if redirect table was not to be updated.

The output of ASRE block 302 is transmitted to decision logic 303 which determines how the response is to be classified and transmits this determination to inference engine 201. One skilled in the art could readily envision other grammar constructs.

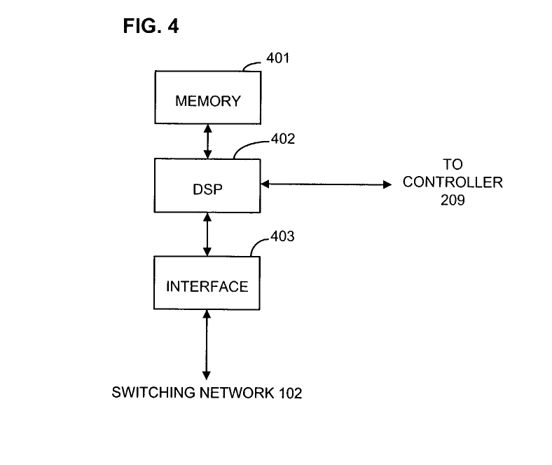

Consider now tone detector 203. FIG. 4 illustrates, in block diagram form, greater details of tone detector 203 of FIG. 2. Processor 402 receives audio samples from switching network 102 via interface 403, communicates command information and data with controller 209 and transmits the results of the analysis to inference engine 201. If additional calculation power is required, processor block 402 could include a DSP. Processor 402 utilizes memory 401 to store program and data. In order to perform tone detection, processor 402 both analyzes frequencies being received from switching network 102 and timing patterns. For example, a set of timing patterns may indicate that the cadence is that of ringback. Tones such as ring back, dial tone, busy tone, reorder tone, etc. have definite timing patterns as well as defined frequencies. The problem is that the precision of the frequencies used for these tones is not always good. The actual frequencies can vary greatly. To detect these types of tones, processor 402 implements the timing pattern analysis using techniques well known to those skilled in the art. For tones such as SIT, modem, fax, etc., processor 402 uses frequency analysis. For the frequency analysis, processor 402 advantageously utilizes the Goertzel algorithm which is a type of Discrete Fourier transform. One skilled in the art readily knows how to implement the Goertzel algorithm on processor 402 and to implement other algorithms for the detection of frequency. Further, one skilled in the art would readily realize that a digital filter could be used. When processor 402 is instructed by controller 209 that redirection is taking place, it receives audio samples from switching network 102 and processes this information utilizing memory 401. Once processor 402 has determined the classification of the audio samples, it transmits this information to inference engine 201. Note, processor 402 will also indicate to inference engine 201 the confidence that processor has attached to its redirection determination.

Consider now in greater detail energy analysis block 206 of FIG. 2. Energy analysis block 206 could be implemented by an interface, processor, and memory similar to that shown in FIG. 4 for tone detector 203. Using well known techniques for detecting the energy in audio samples, energy analysis block 206 is used for answering machine detection, silence detection, and voice activity detection. Energy analysis block 206 performs answering machine detection by looking for the cadence in energy being received back in the voice samples. For example, if the energy of audio samples being received back from the destination endpoint is a high burst of energy that could be the word “hello” and then, followed by low energy of the audio samples that could be “silence”, energy analysis block 206 determines that an answering machine has not responded to the call but rather a human has. However, if the energy being received back in the audio samples appears to be how words would be spoken into an answering machine for a message, energy analysis block 206 determines that this is an answering machine. Silence detection is performed by simply observing the audio samples over a period of time to determine the amount of energy activity. Energy analysis block 206 performs voice activity detection in a similar manner to that done in answering machine detection. One skilled in the art would readily know how to implement these operations on a processor.

Consider now in greater detail zero crossing analysis block 204. This block is implemented on similar hardware to that shown in FIG. 4 for tone detector 203. Zero crossing analysis block 204 not only performs zero crossing analysis but also utilizes peak-to-peak analysis. There are numerous techniques for performing zero crossing and peak to peak analysis all of which are well known to those skilled in the art. One skilled in the art would know how to implement zero crossing and peak-to-peak analysis on a processor similar to processor 402 of FIG. 4. Zero crossing analysis block 204 is utilized to detect speech, tones, and music. Since voice samples will be composed of unvoiced and voiced segments, zero crossing analysis block 204 can determine this unique pattern of zero crossings utilizing the peak to peak information to distinguish voice from those audio samples that contain tones or music. Tone detection is performed by looking for periodically distributed zero crossings utilizing the peak-to-peak information. Music detection is more complicated, and zero crossing analysis block 204 relies on the fact that music has many harmonics which result in a large number of zero crossings in comparison to voice or tones.

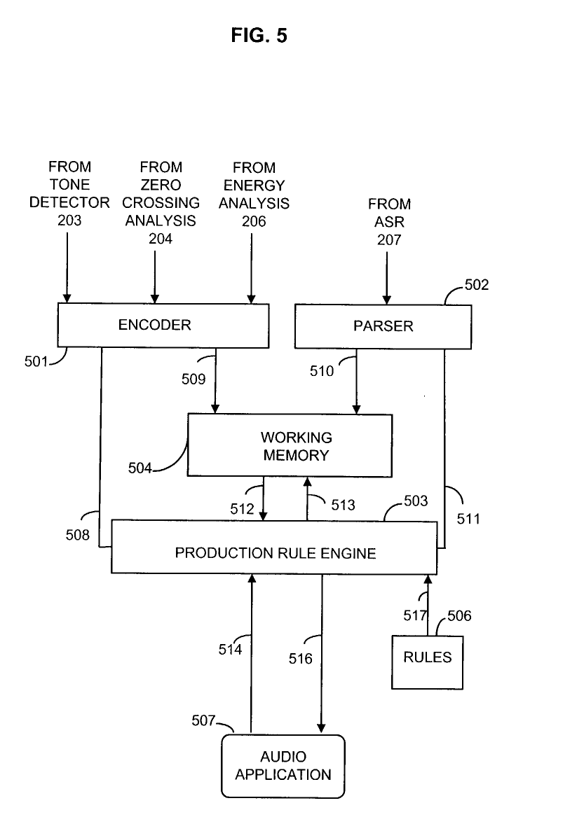

FIG. 5 illustrates an embodiment for the inference engine. FIG. 5 is utilized with all of the embodiments of ASR block 207. With respect to FIG. 5, when the inference engine of FIG. 5 is utilized with the first embodiment of ASR block 207, it is receiving only word phonemes from ASR block 207; however, when it is working with the second and third embodiments of ASR block 207, it receives both word and tone phonemes. When inference engine 201 is used with the second embodiment of ASR block 207, parser 502 receives word phonemes and tone phonemes on separate message paths from ASR block 207 and processes the word phonemes and the tone phonemes as separate audio streams. In the third embodiment, parser 502 receives the word and tones phonemes on a single message path from ASR block 207 and processes combined word and tone phonemes as one audio stream.

Encoder 501 receives the outputs from the simple detectors which are blocks 203, 204, and 206 and converts these outputs into facts that are stored in working memory 504 via path 509. The facts are stored in production rule format.

Parser 502 receives only word phonemes for the first embodiment of ASR block 207, word and tone phonemes as two separate audio streams in the second embodiment of ASR block 207, and word and tone phonemes as a single audio stream in the third embodiment of block 207. Parser 502 receives the phonemes as text and uses a grammar that defines legal responses to determine facts that are then stored in working memory 504 via path 510. An illegal response causes parser 502 to store an unknown as a fact in working memory 504. When both encoder 501 and parser 502 are done, they send start commands via paths 508 and 511, respectively, to production rule engine (PRE) 503.

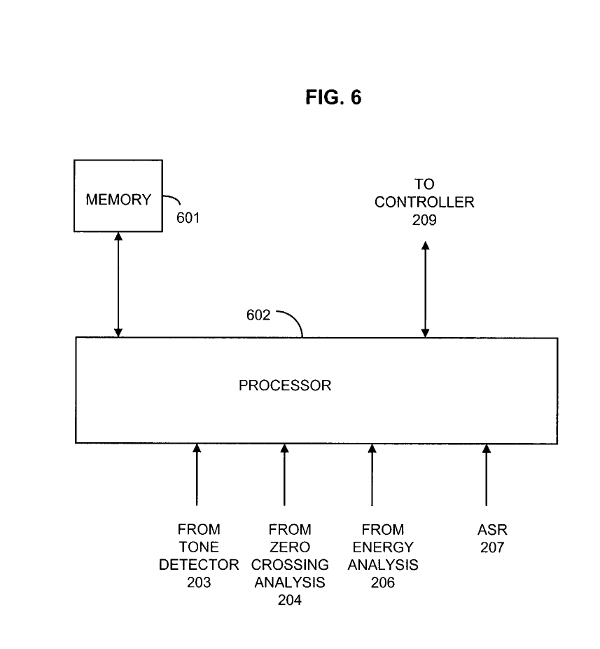

Production rule engine 503 takes the facts (evidence) via path 512 that has been stored in working memory 504 by encoder 501 and parser 502 and applies the rules stored in 506. As rules are applied, some of the rules will be activated causing facts (assertions) to be generated that are stored back in working memory 504 via path 513 by production rule engine 503. On another cycle of production rule engine 503, these newly stored facts (assertions) will cause other rules to be activated. These other rules will generate additional facts (assertions) that may inhibit the activation of earlier activated rules on a later cycle of production rule engine 503. Production rule engine 503 is utilizing forward chaining. However, one skilled in the art would readily realize that production rule engine 503 could be utilizing other methods such as backward chaining. The production rule engine continues the cycle until no new facts (assertions) are being written into memory 504 or until it exceeds a predefined number of cycles. Once production rule engine has finished, it sends the results of its operations to audio application 507. As is illustrated in FIG. 6, blocks 501-507 are implemented on a common processor. Audio application 507 then sends the response to controller 209.

FIG. 6 illustrates advantageously one hardware embodiment of inference engine 201. One skilled in the art would readily realize that inference engine could be implement in many different ways including wired logic. Processor 602 receives the classification results or evidence from blocks 203-207 and processes this information utilizing memory 601 using well-established techniques for implementing an inference engine based on the rules. The rules are stored in memory 601. The final classification decision is then transmitted to controller 209.

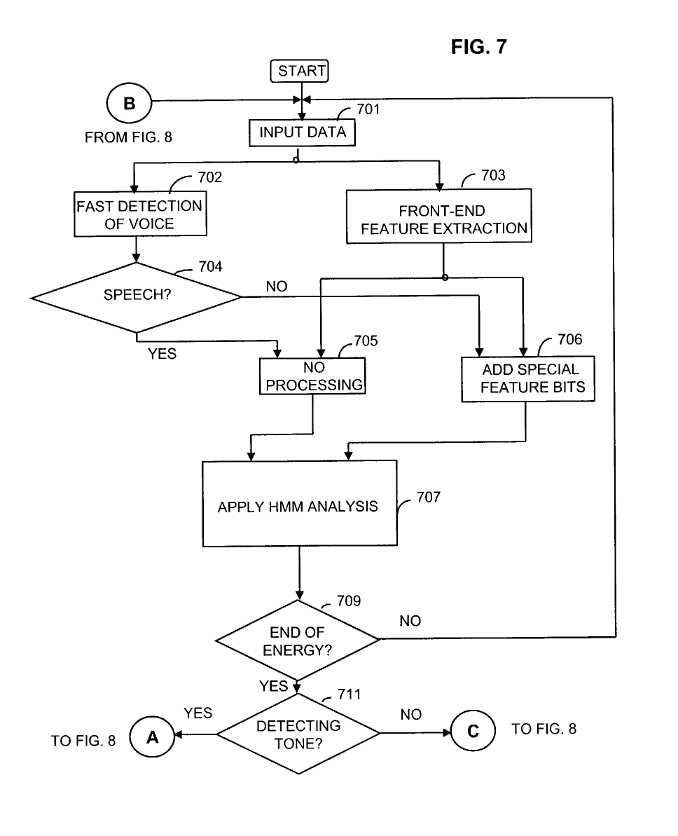

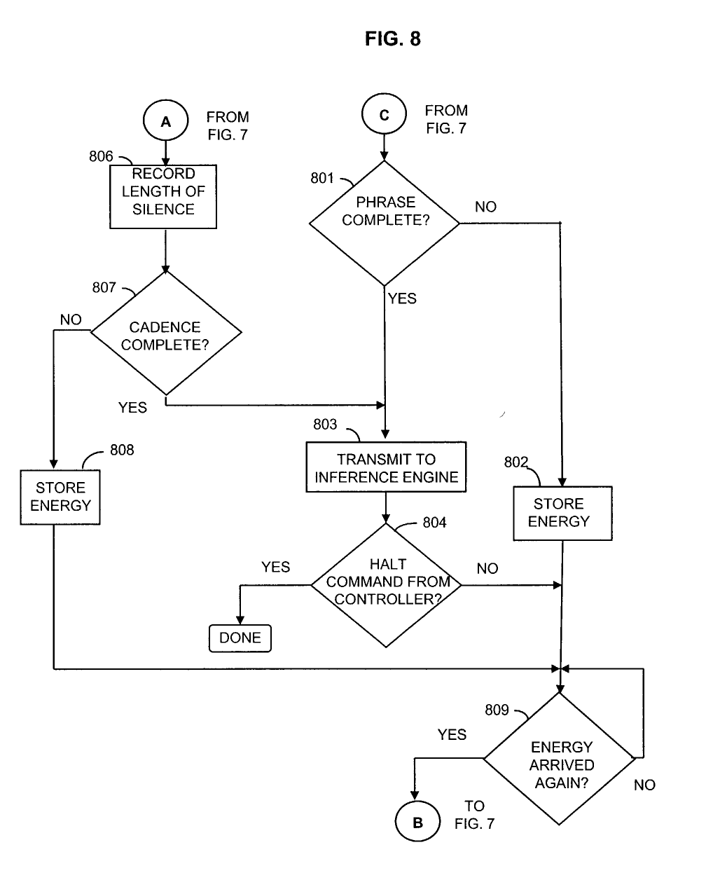

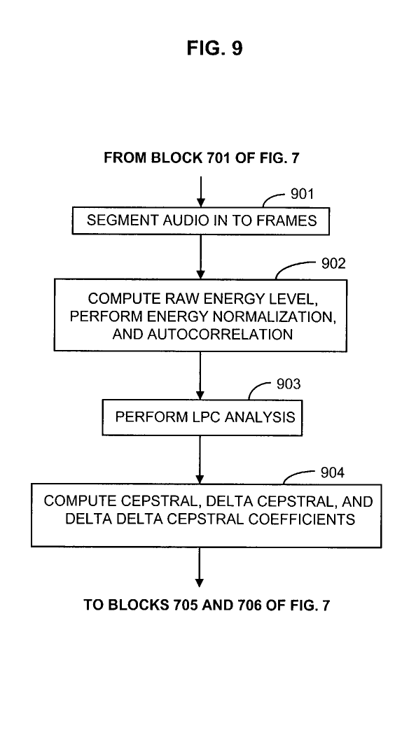

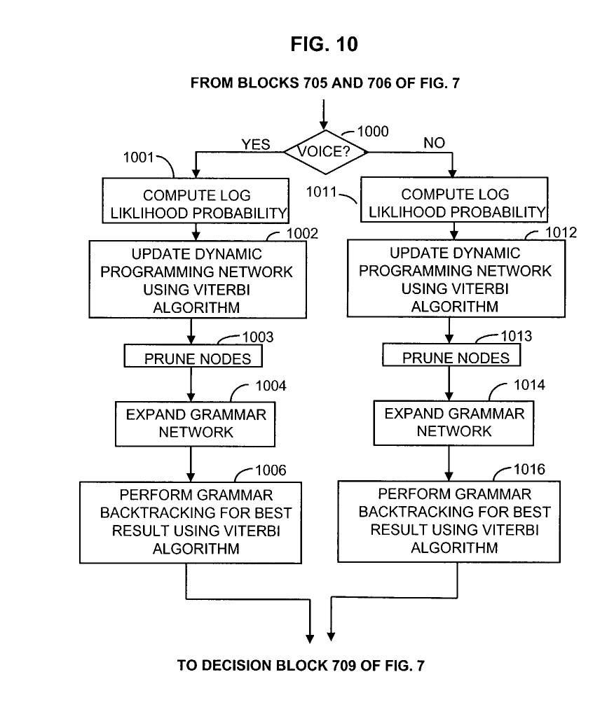

The second embodiment of block 207 is illustrated, in flowchart form, in FIGS. 7 and 8. One skilled in the art would readily realize that other embodiments could be utilized. Block 701 accepts 10 milliseconds of framed data from switching network 102. This information is in 16 bit linear input form in the present embodiment. However, one skilled in the art would readily realize that the input could be in any number of formats including but not limited to 16 bit or 32 bit floating point. This data is then processed in parallel by blocks 702 and 703. Block 702 performs a fast speech detection analysis to determine whether the information is a speech or a tone. The results of block 702 are transmitted to decision block 704. In response, decision block 704 transmits a speech control signal to block 705 or a tone control signal to block 706. Block 703 performs the front-end feature extraction operation which is illustrated in greater detail in FIG. 9. The output from block 703 is a full feature vector. Block 705 is responsive to this full feature vector from block 703 and a speech control signal from decision block 704 to transfer the unmodified full feature vector to block 707. Block 706 is responsive to this full feature vector from block 703 and a tone control signal from decision block 704 to add special feature bits to the full feature vector identify it as a vector that contains a tone. The output of block 706 is transferred to block 707. Block 707 performs a Hidden Markov Model (HMM) analysis on the input feature vectors. One skilled in the art would readily realize that other alternatives to HMM could be used such as Neural Net analysis. Block 707 as can be seen in FIG. 10 actually performs one of two HMM analysis depending on whether the frames were designated as speech or tone by decision block 704. Every frame of data is analyzed to see whether an end-point is reached. Until the end-point is reached, the feature vector is compared with a stored trained data set to find the best match. After execution of block 707, decision block 709 determines if an end-point has been reached. An end-point is a change in energy for a significant period of time. Hence, decision block 709 detects the end of the energy. If the answer in decision block 709 is no, control is transferred back to block 701. If the answer in decision block 709 is yes, control is transferred to decision block 711 which determines if decoding is for a tone rather than speech. If the answer is no, control is transferred to decision block 801 of FIG. 8.

Decision block 801 determines if a complete phrase has been processed. If the answer is no, block 802 stores the intermediate energy and transfers control to decision block 809 which determines when energy is being processed again. When energy is detected, decision block 809 transfers control to block 701 FIG. 7. If the answer in decision block 801 is yes, block 803 transmits the phrase to inference engine 201. Decision block 804 then determines if a command has been received from controller 209 indicating that the process should be halted. If the answer is no, control is transferred back to block 809. If the answer is yes, no further operations are performed until restarted by controller 209.

Returning to decision block 711 of FIG. 7, if the answer is yes that tone decoding is being performed, control is transferred to block 806 of FIG. 8. Block 806 records the length of silence until new energy is received before transferring control to decision block 807 which determines if a cadence has been processed. If the answer is yes, control is transferred to block 803. If the answer is no, control is transferred to block 808. Block 808 stores the intermediate energy and transfers control to decision block 809.

Block 703 is illustrated in greater detail, in flowchart for, in FIG. 9. Block 901 receives 10 milliseconds of audio data from block 701. Block 901 segments this audio data into frames. Block 902 is responsive to the audio frames to compute the raw energy level, perform energy normalization, and autocorrelation operations all of which are well known to those skilled in the art. The result from block 902 is then transferred to block 903 which performs linear predictive coding (LPC) analysis to obtain the LPC coefficients. Using the LPC coefficients, block 904 computes the Cepstral, Delta Cepstral, and Delta Delta Cepstral coefficients. The result from block 904 is the full feature vector which is transmitted to blocks 705 and 706.

Block 707 is illustrated in greater detail in FIG. 10. Decision block 1000 makes the initial decision whether the information is to be processed as a speech or a tone utilizing the information that was inserted or not inserted into the full feature vector in blocks 706 and 705, respectively, of FIG. 7. If the decision is that it is voice, block 1001 computes the log likelihood probability that the phonemes of the vector compare to phonemes in the built-in grammar. Block 1002 then takes the result from 1001 and updates the dynamic programming network using the Viterbi algorithm based on the computed log likelihood probability. Block 1003 then prunes the dynamic programming network so as to eliminate those nodes that no longer apply based on the new phonemes. Block 1004 then expands the grammar network based on the updating and pruning of the nodes of the dynamic programming network by blocks 1002 and 1003. It is important to remember that the grammar defines the various words and phrases that are being looked for; hence, this can be applied to the dynamic programming network. Block 1006 then performs grammar backtracking for the best results using the Viterbi algorithm. A potential result is then passed to block 709 for its decision.

Blocks 1011 through 1016 perform similar operations to those of blocks 1001 through 1006 with the exception that rather than using a grammar based on what is expected as speech, the grammar defines what is expected in the way of tones. In addition, the initial dynamic programming network will also be different.

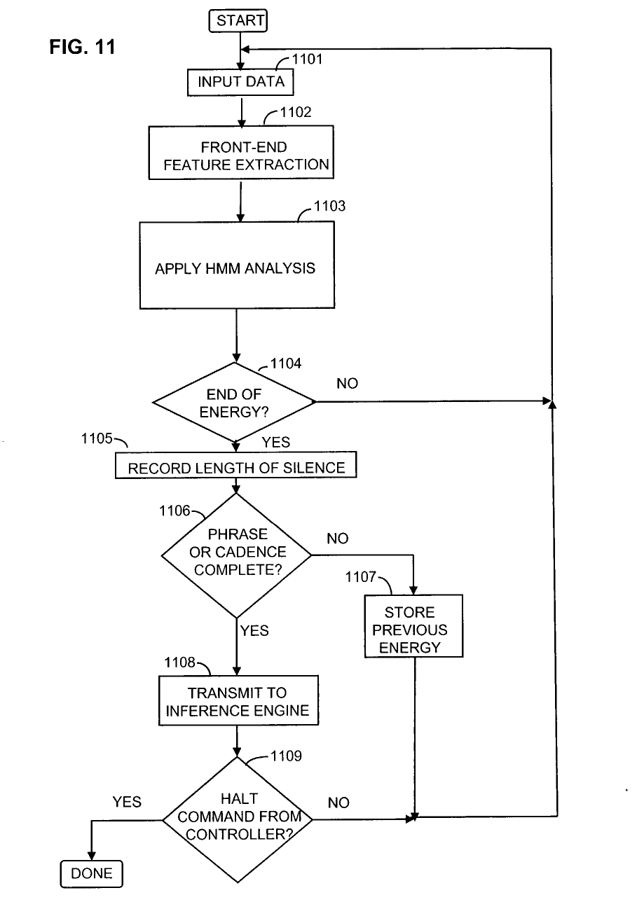

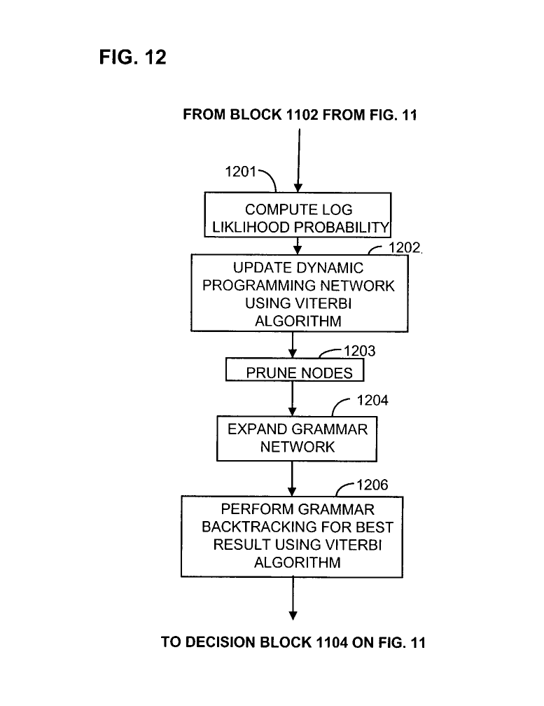

FIG. 11 illustrates, in flowchart form, the third embodiment of block 207. Since in the third embodiment speech and tones are processed in the same HMM analysis, there is no equivalent blocks for block 702, 704, 705, and 706 in FIG. 11. Block 1101 accepts 10 milliseconds of framed data from switching network 102. This information is in 16 bit linear input form. This data is processed by block 1102. The results from block 1102 (which performs similar actions to those illustrated in FIG. 9) are transmitted as a full feature vector to block 1103. Block 1103 is receiving the input feature vectors and performing a HMM analysis utilizing a unified model for both speech and tones. Every frame of data is analyzed to see whether an end-point is reached. (In this context, an end-point is a period of low energy indicating silence.) Until the end-point is reached, the feature vector is compared with the stored trained data set to find the best match. Greater details on block 1103 are illustrated in FIG. 12. After the operation of block 1103, decision block 1104 determines if an end-point has been reached which is a period of low energy indicating silence. If the answer in no, control is transferred back to block 1101. If the answer is yes, control is transferred to block 1105 which records the length of the silence before transferring control to decision block 1106. Decision block 1106 determines if a complete phrase or cadence has been determined. If it has not, the results are stored by block 1107, and control is transferred back to block 1101. If the decision is yes, then the phrase or cadence designation is transmitted on a unitary message path to inference engine 201. Decision block 1109 then determines if a halt command has been received from controller 209. If the answer is yes the processing is finished. If the answer is no, control is transferred back to block 1101.

FIG. 12 illustrates, in flowchart form, greater details of block 1103 of FIG. 11. Block 1201 computes the log likelihood probability that the phonemes of the vector compare to phonemes in the built-in grammar. Block 1202 then takes the result from 1201 and updates the dynamic programming network using the Viterbi algorithm based on the computed log likelihood probability. Block 1203 then prunes the dynamic programming network so as to eliminate those nodes that no longer apply based on the new phonemes. Block 1204 then expands the grammar network based on the updating and pruning of the nodes of the dynamic programming network by blocks 1202 and 1203. It is important to remember that the grammar defines the various words and phrases that are being looked for; hence, this can be applied to the dynamic programming network. Block 1206 then performs grammar backtracking for the best results using the Viterbi algorithm. A potential result is then passed to block 1104 for its decision.

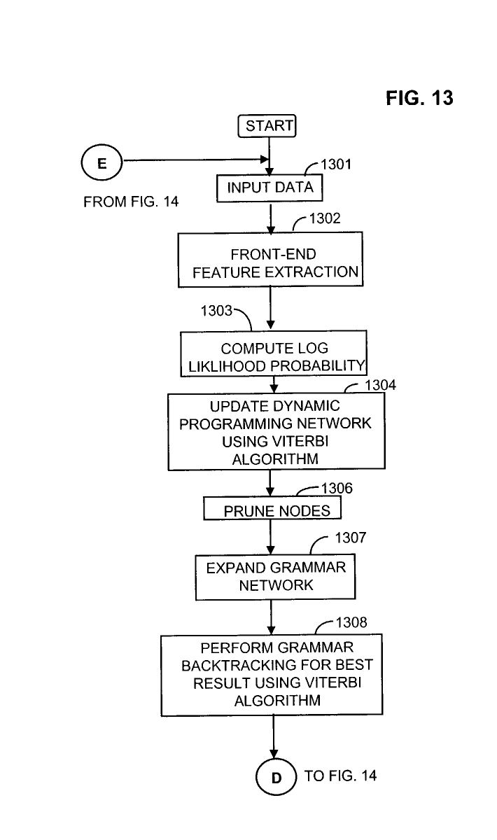

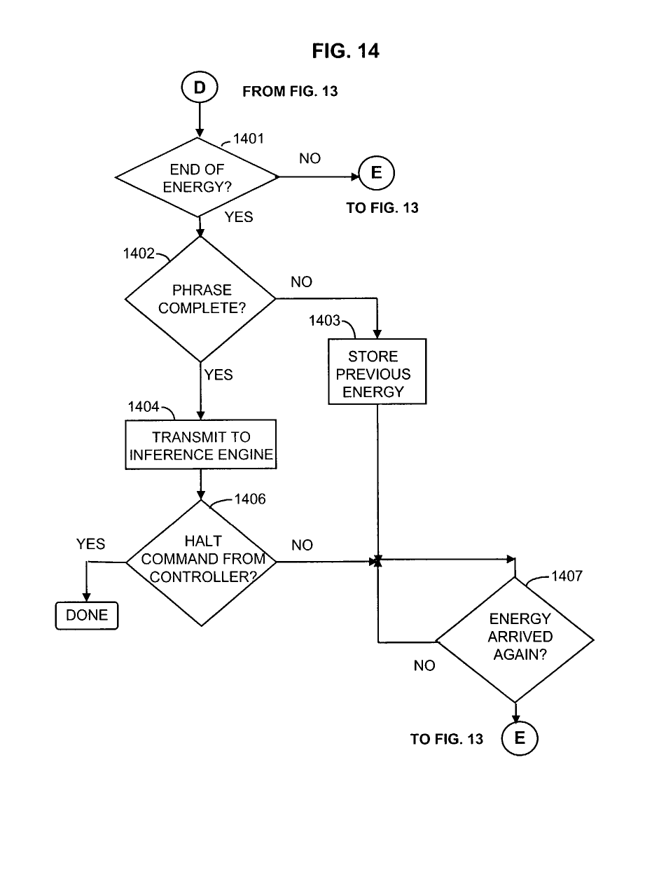

FIGS. 13 and 14 illustrate, in block diagram form, the first embodiment of ASR block 207. Block 1301 of FIG. 13 accepts 10 milliseconds of framed data from switching network 102. This information is in 16 bit linear input form. This data is processed by block 1302. The results from block 1302 (which perform similar actions to those illustrated in FIG. 9) are transmitted as a full feature vector to block 1303. Block 1303 computes the log likelihood probability that the phonemes of the vector compare to phonemes in the built-in speech grammar. Block 1304 then takes the result from 1302 and updates the dynamic programming network using the Viterbi algorithm based on the computed log likelihood probability. Block 1306 then prunes the dynamic programming network so as to eliminate those nodes that no longer apply based on the new phonemes. Block 1307 then expands the grammar network based on the updating and pruning of the nodes of the dynamic programming network by blocks 1304 and 1306. It is important to remember that the grammar defines the various words that are being looked for; hence, this can be applied to the dynamic programming network. Block 1308 then performs grammar backtracking for the best results using the Viterbi algorithm. A potential result is then passed to decision block 1401 of FIG. 14 for its decision.

Decision block 1401 determines if an end-point has been reached which is indicated by a period of low energy. If the answer in no, control is transferred back to block 1301. If the answer is yes in decision block 1401, decision block 1402 determines if a complete phrase has been determined. If it has not, the results are stored by block 1403, and control is transferred to decision block 1407 which determines when energy arrives again. Once energy is determined, decision block 1407 transfers control back to block 1301 of FIG. 13. If the decision is yes in decision block 1402, then the phrase designation is transmitted on a unitary message path to inference engine 201 by block 1404 before transferring control to decision block 1406. Decision block 1406 then determines if a halt command has been received from controller 209. If the answer is yes, the processing is finished. If the answer is no in decision block 1406, control is transferred to block 1407. Whereas, blocks 201-207 have been disclosed as each executing on a separate DSP or processor, one skilled in the art would readily realize that one processor of sufficient power could implement all of these blocks. In addition, one skilled in the art would realize that the functions of these blocks could be subdivided and be performed by two or more DSPs or processors.

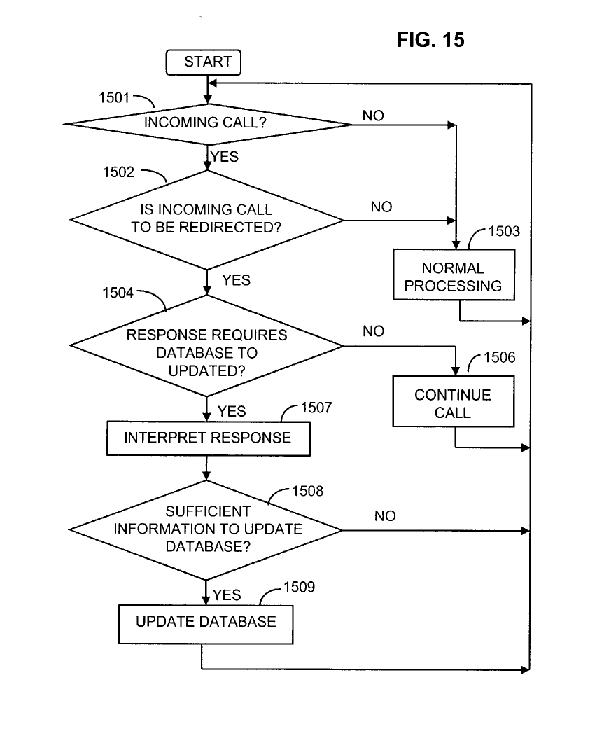

FIG. 15 illustrates an embodiment of the operations performed by control computer 101 and redirection database controller 106 in implementing the invention. Once started, decision block 1501 which is performed by control computer 101, determines if an incoming call is being received. If the answer is no, block 1503 performs normal processing before returning control back to decision block 1501. If the call is an incoming call, decision block 1502 determines if the incoming call is to be redirected based on the contents of redirect table 130. If the answer in decision block 1502 is no, control is transferred once again to block 1503 for normal processing. However, if the incoming call is to be redirected, the call is redirected by block 1502. Then, the decision is made by decision block 1504 if the response received back from the destination point of the redirected call requires redirect table 130 to be updated. If the answer is no in decision block 1504, control is transferred to block 1506 which performs the continuing operations required to complete the call before returning control back to decision block 1501.

If the decision in decision block 1504 is that the response received back from the destination end point requires that the database be updated, block 1507 interprets the response and transfers control to decision block 1508. The latter decision block determines if sufficient information was obtained in block 1507 to actually update redirect table 130. If the answer is no, no action is taken, and control is transferred back to decision block 1501. If there is sufficient information to update redirect table 130, control is transferred to block 1509. Block 1509 is executed by the interexchange of information between redirection database controller 106 and control computer 101 and results in redirect table 130 being updated before control is transferred back to decision block 1501. Blocks 1504 and 1507 may utilize automatic speech recognition techniques to identify information received from the destination end point. However, if the information received from the destination end point is in digital form, the automatic speech recognition techniques are not required as part of the determination of blocks 1504 and 1507. The information could be transmitted in digital form from the destination end point utilizing an ISDN signaling protocol or a similar protocol

Of course, various changes and modifications to the illustrative embodiment described above will be apparent to those skilled in the art. Such changes and modifications can be made without departing from the spirit and scope of the invention and without diminishing its intended advantages. It is therefore intended that such changes and modifications be covered by the following claims except in so far as limited by the prior art.

What is claimed is:

1. A method for updating a call redirection database, comprising the steps of:
detecting redirection of a call;
receiving semantic information from an destination endpoint;
determining if the redirection database should be changed based on the received semantic information;
identifying new redirection database information from the received semantic information; and
updating the redirection database with the new redirection database information.

2. The method of claim 1 wherein the step of receiving comprises the step of receiving speech information; and
the step of determining further determining if the received speech information indicates that the redirection database should be changed.

3. The method of claim 2 wherein the step of determining comprises the step of performing speech recognition on the received speech information.

4. The method of claim 3 wherein the step of performing speech recognition comprises the step of executing a Hidden Markov Model to determine the presence of words in the speech information.

5. The method of claim 4 wherein the step of executing comprises the step of using a grammar for speech.

6. The method of claim 1 wherein the step of receiving comprises the step of receiving speech information; and
the step of identifying comprises the step of performing speech recognition on the received speech information to determined the new redirection database information.

7. The method of claim 6 wherein the step of performing speech recognition comprises the step of executing a Hidden Markov Model to determine the presence of words in the speech information.

8. The method of claim 7 wherein the step of executing comprises the step of using a grammar for speech.

9. An apparatus for updating redirection database in response to an incoming call, comprising:
a control computer of a switching system responsive to the incoming call and redirection information in a redirection database for communicating the incoming call to a destination endpoint via the switching system;
a redirection database controller responsive to redirection information received from the destination endpoint for providing new redirection database information for the redirection database; and
the control computer responsive to the provided redirection information for modifying the redirection database.

10. The apparatus of claim 9 wherein the redirection database controller further responsive to the received redirection information for determining if the redirection database should be modified and for identifying the provided redirection information.

11. The apparatus of claim 10 wherein the received redirection information is speech information; and
the redirection database controller determines if the received speech information indicates that the redirection database should be changed.

12. The apparatus of claim 11 wherein the redirection database controller uses speech recognition on the received speech information to make the determination.

13. The apparatus of claim 12 wherein the speech recognition comprises executing a Hidden Markov Model to determine the presence of words in the speech information.

14. The apparatus of claim 13 wherein the executing comprises using a grammar for speech.

15. The apparatus of claim 10 wherein the received redirection information is speech information; and
the redirection database controller identifies using speech recognition to provided the new redirection database information.

16. The apparatus of claim 15 wherein the redirection database controller performs speech recognition by executing a Hidden Markov Model to determine the presence of words in the speech information.

17. The apparatus of claim 16 wherein the executing comprises using a grammar for speech.

18. An apparatus for updating redirection database in response to an outgoing call, comprising:
a control computer of a switching system responsive to the outgoing call for communicating the outgoing call to a destination endpoint via the switching system;
a redirection database controller responsive to redirection information received from the destination endpoint for providing new redirection database information for the redirection database; and
the control computer responsive to the provided redirection information for modifying the redirection database.

19. The apparatus of claim 18 wherein the redirection database controller further responsive to the received redirection information for determining if the redirection database should be modified and for identifying the provided redirection information.

20. The apparatus of claim 19 wherein the received redirection information is speech information; and
the redirection database controller determines if the received speech information indicates that the redirection database should be changed.

21. The apparatus of claim 20 wherein the redirection database controller uses speech recognition on the received speech information to make the determination.

22. The apparatus of claim 21 wherein the speech recognition comprises executing a Hidden Markov Model to determine the presence of words in the speech information.

23. The apparatus of claim 22 wherein the executing comprises using a grammar for speech.

24. The apparatus of claim 19 wherein the received redirection information is speech information; and
the redirection database controller identifies using speech recognition to provided the new redirection database information.

25. The apparatus of claim 24 wherein the redirection database controller performs speech recognition by executing a Hidden Markov Model to determine the presence of words in the speech information.

26. The apparatus of claim 25 wherein the executing comprises using a grammar for speech.

27. A processor-readable medium comprising processor-executable instructions configured for:
detecting redirection of a call;
receiving semantic information from an destination endpoint;
determining if the redirection database should be changed based on the received semantic information;
identifying new redirection database information from the received semantic information; and
updating the redirection database with the new redirection database information.

28. The processor-readable medium of claim 27 wherein the receiving comprises receiving speech information; and
determining if the received speech information indicates that the redirection database should be changed.

29. The processor-readable medium of claim 28 wherein the determining comprises performing speech recognition on the received speech information.

30. The processor-readable medium of claim 29 wherein the performing speech recognition comprises executing a Hidden Markov Model to determine the presence of words in the speech information.

31. The processor-readable medium of claim 30 wherein the executing comprises using a grammar for speech.

32. The processor-readable medium of claim 27 wherein the receiving comprises receiving speech information; and
the identifying comprises performing speech recognition on the received speech information to determined the new redirection database information.

33. The processor-readable medium of claim 32 wherein the performing speech recognition comprises executing a Hidden Markov Model to determine the presence of words in the speech information.

34. The processor-readable medium of claim 33 wherein the executing comprises using a grammar for speech.
